(19) United States
(12) Patent Application Publication
(10) Pub. No.: US 2023/0153873 A1
(43) Pub. Date: May 18, 2023

(54) SYSTEM AND METHOD FOR MONITORING STATUS OF USER ACCOUNT

(71) Applicant: AT&T Intellectual Property I, L.P., Atlanta, GA (US)

(72) Inventors: Qiuying Jiang, Sunnyvale, CA (US); Ana Armenta, San Jose, CA (US); Prince Paulraj, Coppell, TX (US); Jean Luo, Millbrae, CA (US)

(73) Assignee: AT&T Intellectual Property I, L.P., Atlanta, GA (US)

(21) Appl. No.: 17/529,964

(22) Filed: Nov. 18, 2021

(51) Int. Cl. G06Q 30/04; G06F 16/23

(52) U.S. Cl. CPC G06Q 30/04; G06F 16/2379

(57) ABSTRACT

Aspects of the subject disclosure may include, for example, obtaining first information indicative of a first change to a first aspect of a user account; applying some or all of the first information to a first model to determine a first score associated with the first change; aggregating the first score with one or more first prior scores associated with one or more prior changes to the first aspect of the user account, resulting in a first aggregate score; obtaining second information indicative of a second change to a second aspect of the user account; applying some or all of the second information to a second model, that is different from the first model, to determine a second score associated with the second change; aggregating the second score with one or more second prior scores associated with one or more prior changes to the second aspect of the user account, resulting in a second aggregate score; and storing the first aggregate score and the second aggregate score in a database. Other embodiments are disclosed.

### FIELD OF THE DISCLOSURE

The subject disclosure relates to a system and a method for monitoring status of a user account.

### BACKGROUND

Fraud is a principal profit leakage area, and it causes significant financial losses across different industries in the business world. With the development and improvement of rule-based systems, as well as multiple machine learning models that can run in real-time, certain conventional mechanisms provide limited ability to predict and stop fraudulent transactions in a timely manner.

Further, certain conventional fraud prevention solutions related to account changes have been built using the following approaches: 1) Static business rules that are created and updated manually; 2) Propagated account changes that pass information to the subsequent order submission sessions; 3) Single machine learning inference towards one account change event. However, such approaches are typically neither cost-friendly nor provide the whole picture of a customer's account health automatically (because such approaches depend on a large amount of human-involved work, such as rule creation and transaction review).

Finally, in connection with a mechanism to monitor account changes, certain conventional mechanisms have used one model and have scored only one change to an account.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a communication network in accordance with various aspects described herein.

FIG. 2A is a block diagram illustrating an example, non-limiting embodiment of a process (that can function fully or partially within the communication network of FIG. 1) in accordance with various aspects described herein.

FIG. 2B depicts an illustrative embodiment of a method in accordance with various aspects described herein.

FIG. 2C depicts an illustrative embodiment of a method in accordance with various aspects described herein.

FIG. 2D depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for monitoring a status of a user account, and/or providing fraud detection, and/or providing fraud mitigation, and/or providing fraud prevention. Other embodiments are described in the subject disclosure.

One or more aspects of the subject disclosure include an account health monitoring system that enables a comprehensive solution to monitor the health of customers' accounts in a timely manner and that prevents a business from incurring significant financial losses (e.g., losses that are caused by account takeovers and subsequent account changes). In various embodiments, the system can use multiple machine learning models to generate (e.g., in real-time) propensity scores for every single account change event and to aggregate each specific kind of account change propensity score by account using various aggregation functions (in one specific example, a single aggregation function can be used to aggregate multiple account change propensity scores; in another specific example, a particular aggregation function can be used to aggregate one or more particular account change propensity scores and another (different) aggregation function can be used to aggregate one or more other (different) account change propensity scores). In various embodiments, a feature store (e.g., one or more databases) can be used to store the common features fed to each model as well as the aggregated scores for each account (in one specific example, the aggregated scores for each account can be stored as key and value pairs).

As described herein, in various embodiments an automated job can run frequently (e.g., daily, hourly, every minute) based upon relevant business needs to update the aggregated scores (and to monitor the overall customer account health). This brings flexibility and expandability to various embodiments by combining both real-time and batch scoring. As a result, various embodiments can help a business to make dynamic decisions based upon the real-time propensity scores and to monitor the overall account health passively using the aggregated propensity scores.

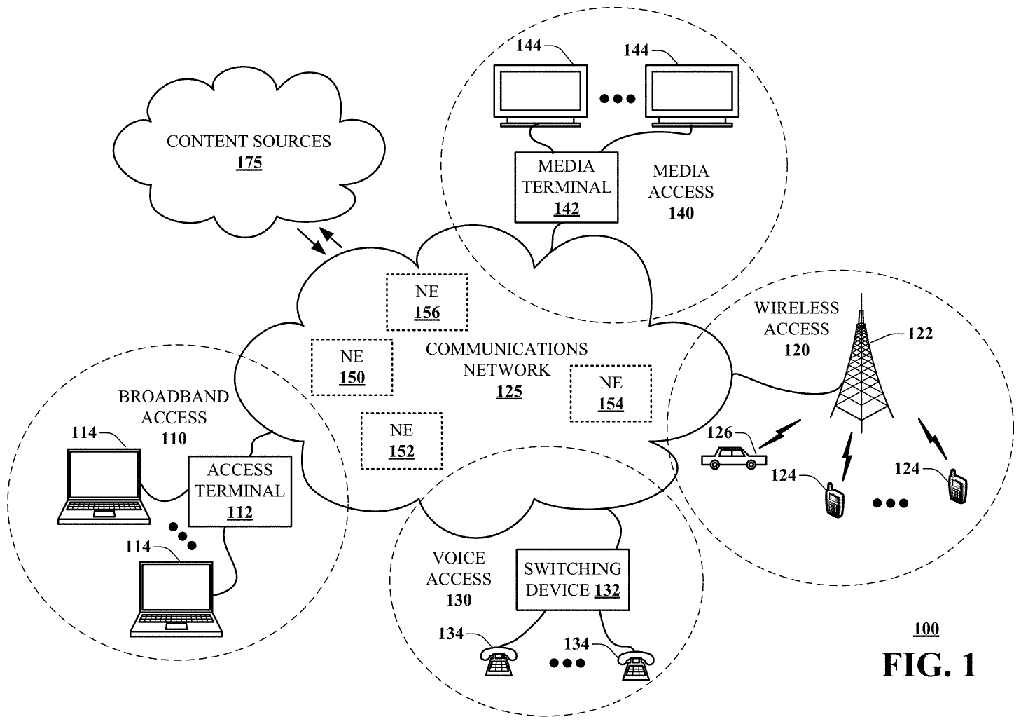

Referring now to FIG. 1, a block diagram is shown illustrating an example, non-limiting embodiment of a system 100 in accordance with various aspects described herein. For example, system 100 can facilitate in whole or in part monitoring a status of a user account, and/or providing fraud detection, and/or providing fraud mitigation, and/or providing fraud prevention. In particular, a communication network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

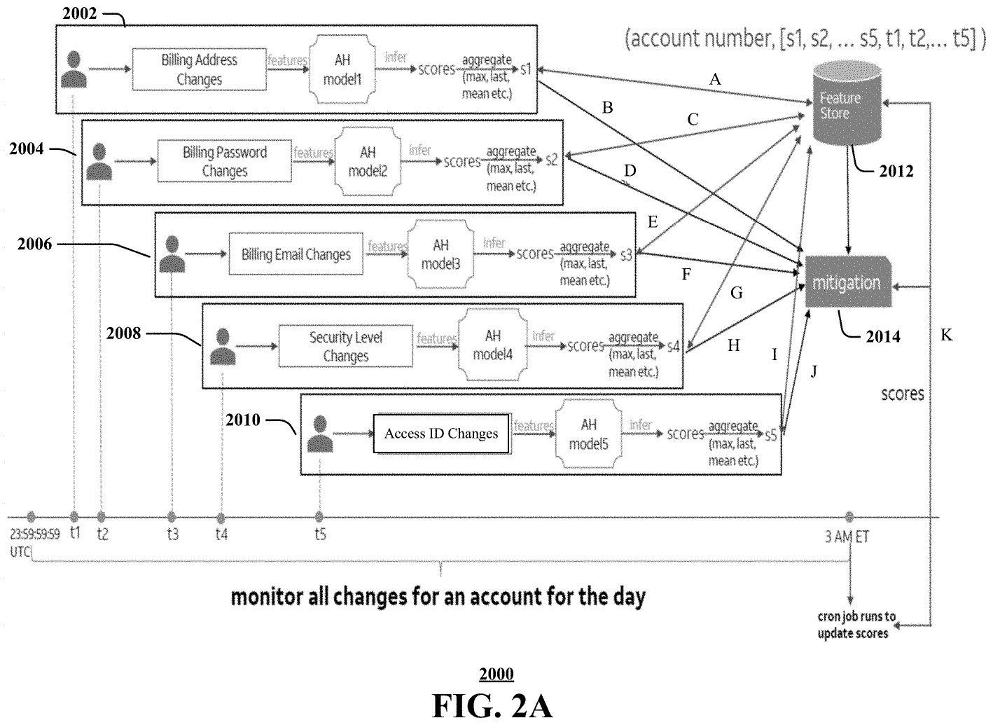

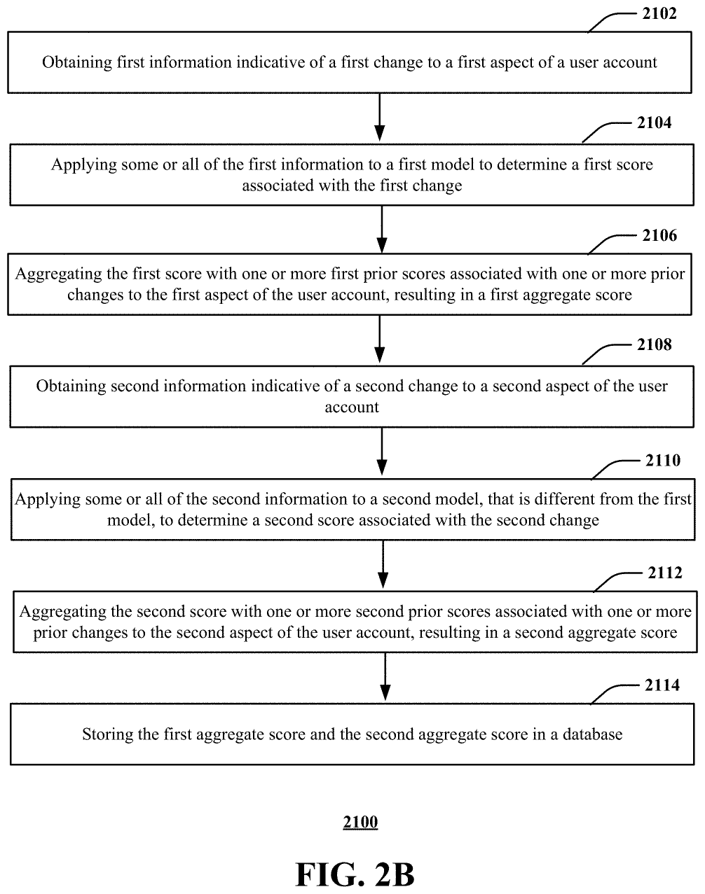

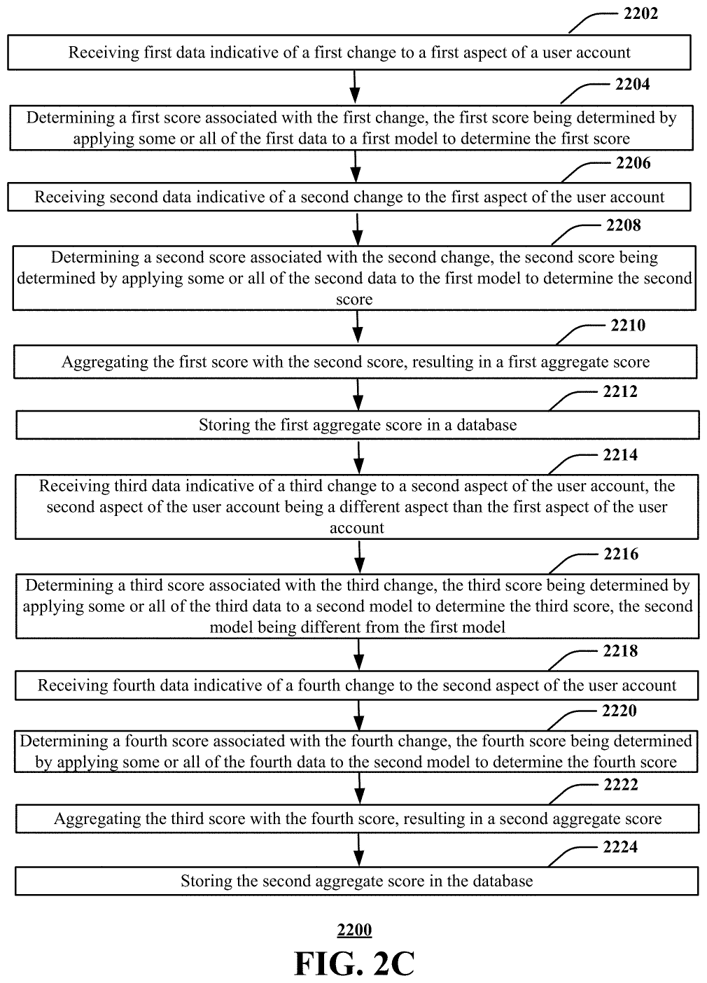

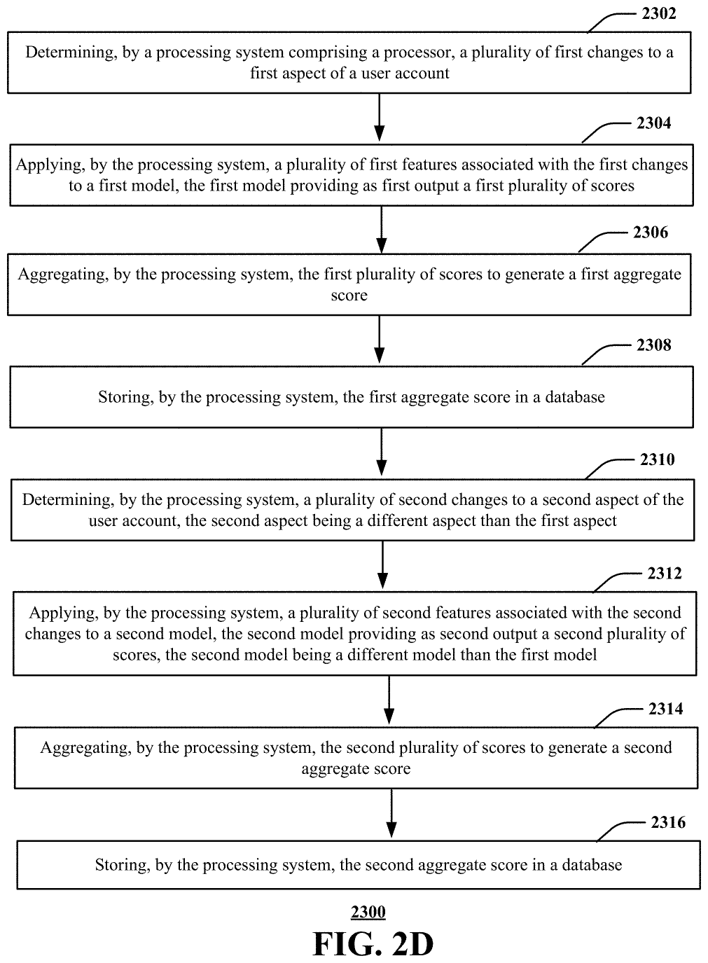

Referring now to FIG. 2A, this is a block diagram illustrating an example, non-limiting embodiment of a workflow process 2000 (that can function fully or partially within the communication network of FIG. 1) in accordance with various aspects described herein. As seen in this figure, the process 2000 can, for example, monitor all changes for an account for a given day and/or other time period such as week, month, hour, minute, etc. (the time period can be dependent, for example, on the type of account and/or the activity of the account). More particularly, the sub-process 2002 (which, in this example, starts at time t1) can monitor billing address change(s) associated with a user and/or user account. Such billing address change(s) can result in one or more corresponding features being supplied to an account health model (shown in this figure as AH model1). Based upon AH model1, one or more corresponding scores can be generated (e.g., inferred). Further, the scores from AH model1 can be aggregated (e.g., max score, last score, mean score, etc.) to produce a corresponding aggregate score (shown in this figure as S1). Score S1 can be supplied to feature store 2012 (see arrow “A”). Further, feature store 2012 can provide to sub-process 2002 one or more scores (and/or one or more features) that are stored in feature store 2012 (see arrow “A”). In one specific example, feature store 2012 can comprise a database. Score S1 can also be supplied to mitigation process 2014 (see arrow “B”). This mitigation process 2014 can, for example, collect other scores as described herein and then perform mitigation such as account closing, transaction blocking, contacting a user, etc.

Still referring to FIG. 2A, sub-process 2004 (which, in this example, starts at time t2) can monitor billing password change(s) associated with the user and/or user account. Such billing password change(s) can result in one or more corresponding features being supplied to an account health model (shown in this figure as AH model2). Based upon AH model2, one or more corresponding scores can be generated (e.g., inferred). Further, the scores from AH model2 can be aggregated (e.g., max score, last score, mean score, etc.) to produce a corresponding aggregate score (shown in this figure as S2). Score S2 can be supplied to feature store 2012 (see arrow “C”). Further, feature store 2012 can provide to sub-process 2004 one or more scores (and/or one or more features) that are stored in feature store 2012 (see arrow “C”). Score S2 can also be supplied to mitigation process 2014 (see arrow “D”).

Still referring to FIG. 2A, sub-process 2006 (which, in this example, starts at time t3) can monitor billing email change(s) associated with the user and/or user account. Such billing email change(s) can result in one or more corresponding features being supplied to an account health model (shown in this figure as AH model3). Based upon AH model3, one or more corresponding scores can be generated (e.g., inferred). Further, the scores from AH model3 can be aggregated (e.g., max score, last score, mean score, etc.) to produce a corresponding aggregated score (shown in this figure as S3). Score S3 can be supplied to feature store 2012 (see arrow “E”). Further, feature store 2012 can provide to sub-process 2006 one or more scores (and/or one or more features) that are stored in feature store 2012 (see arrow “E”). Score S3 can also be supplied to mitigation process 2014 (see arrow “F”).

Still referring to FIG. 2A, sub-process 2008 (which, in this example, starts at time t4) can monitor security level change(s) associated with the user and/or user account. Such security level change(s) can result in one or more corresponding features being supplied to an account health model (shown in this figure as AH model4). Based upon AH model4, one or more corresponding scores can be generated (e.g., inferred). Further, the scores from AH model4 can be aggregated (e.g., max score, last score, mean score, etc.) to produce a corresponding aggregate score (shown in this figure as S4). Score S4 can be supplied to feature store 2012 (see arrow “G”). Further, feature store 2012 can provide to sub-process 2008 one or more scores (and/or one or more features) that are stored in feature store 2012 (see arrow “G”). Score S4 can also be supplied to mitigation process 2014 (see arrow “H”).

Still referring to FIG. 2A, sub-process 2010 (which, in this example, starts at time t5) can monitor access ID change(s) associated with the user and/or user account. Such access ID change(s) can result in one or more corresponding features being supplied to an account health model (shown in this figure as AH model5). Based upon AH model5, one or more corresponding scores can be generated (e.g., inferred). Further, the scores from AH model5 can be aggregated (e.g., max score, last score, mean score, etc.) to produce a corresponding aggregate score (shown in this figure as S5). Score S5 can be supplied to feature store 2012 (see arrow “I”). Further, feature store 2012 can provide to sub-process 2010 one or more scores (and/or one or more features) that are stored in feature store 2012 (see arrow “I”). Score S5 can also be supplied to mitigation process 2014 (see arrow “J”).

Still referring to FIG. 2A, the feature store 2012 can, for example, store the data for each account number as a plurality of scores and corresponding timestamps (e.g., account number, [51, S2 . . . S5, t1, t2 . . . t5]). Further, as seen, score(s) can be communicated (see arrow “K”) between and/or among feature store 2012, mitigation process 2014 and one or more cron jobs (e.g., a Linux command used for scheduling tasks to be executed sometime in the future automatically) that are run to update the scores.

In various embodiments, monitoring can be provided for any desired number of users (each of which users can have any desired number of account(s)). In various embodiments, the monitoring can be performed for any desired number of days (and/or for any desired number of other time frames, such as hourly, weekly, monthly). In various embodiments, the account change data can come from one or more servers (each of which can be associated with one or more users and/or with one or more user accounts). In various examples, each user account can be an online service account, an online shopping account, a bank account, a credit card account, a debit card account, or any combination thereof

Reference will now be made to certain “features” that can be used (e.g., input to one or more models and/or stored in one or more databases (or feature stores)). In various examples, the “features” used can include one or more of:
a) Payload features of different account changes, such as:
   Authorized username change
   Billing address change
   Billing email change
   Security level change
b) Derived features from linkage to other data sources, such as:
   User login/authentication data
c) Velocity features (e.g., a kind of feature that captures some behavior that happened in a past time window—for instance, number of username changes in past one week)
d) IP (Internet Protocol) related features, such as:
   Distance in miles between IP address and billing address
e) Geolocation related features

Reference will now be made to an Orchestration Pipeline according to various embodiments. In this regard, such an Orchestration Pipeline can comprise a feature store that will store common features used by individual models. In one example, the feature store can encapsulate REDIS as its backend. In one example, the model specific Orchestration Pipeline can combine common features and model specific features to generate the full feature vector fed to account health models for scoring. Individual account health model scores and aggregated scores can be stored back to the feature store as features.

Reference will now be made to certain score aggregation according to various embodiments (see, also, aggregation of scores by sub-processes 2002, 2004, 2006, 2008, 2010 of FIG. 2A). In this regard, to have a comprehensive view about customer account health, a customized aggregation function can be used to aggregate all propensity scores for a specific kind of customer account change into one single score. In various examples, one or more of the following aggregation functions can be used:
Mean—use the average value of all scores as the aggregated score (this will, for example, give a general view about the account health)
Max—use the maximum value of all scores as the aggregated score (this will, for example, emphasize the risk of the account having been hacked (or otherwise compromised) in the past
Latest—use only the latest value of all scores as the aggregated score (this will, for example, keep the freshness of the propensity score and provide the freshest view of the account health)
Optimized Max—combine the maximum value of all scores with considering number of account change events and removing the impact of outliers (explanation as below):

$$Aggregated Score = \frac{Max ( S )}{SD} * N$$

$${}^{*} Propensity score collection S = \{ s 1 , s 2 , s 3 … sn \}$$

In various examples, each of sub-processes 2002, 2004, 2006, 2008, 2010 of FIG. 2A can use one or more of the aggregation functions mentioned above.

Referring now to FIG. 2B, various steps of a method 2100 according to an embodiment are shown. As seen in this FIG. 2B, step 2102 comprises obtaining first information indicative of a first change to a first aspect of a user account. Next, step 2104 comprises applying some or all of the first information to a first model to determine a first score associated with the first change. Next, step 2106 comprises aggregating the first score with one or more first prior scores associated with one or more prior changes to the first aspect of the user account, resulting in a first aggregate score. Next, step 2108 comprises obtaining second information indicative of a second change to a second aspect of the user account. Next, step 2110 comprises applying some or all of the second information to a second model, that is different from the first model, to determine a second score associated with the second change. Next, step 2112 comprises aggregating the second score with one or more second prior scores associated with one or more prior changes to the second aspect of the user account, resulting in a second aggregate score. Next, step 2114 comprises storing the first aggregate score and the second aggregate score in a database.

In various examples, the obtaining of the first information can occur in real-time, essentially as the first change is made. In various examples, the obtaining of the first information can occur within a first threshold time period of the occurrence of the first change; in various specific examples the first threshold time period can be 1 second, 5 seconds, 10 seconds, 1 minute, 5 minutes, or 1 day. In various examples, the obtaining of the second information can occur in real-time, essentially as the second change is made. In various examples, the obtaining of the second information can occur within a second threshold time period of the occurrence of the second change; in various specific examples the second threshold time period can be 1 second, 5 seconds, 10 seconds, 1 minute, 5 minutes, or 1 day. In one example, the first threshold and the second threshold can be the same value. In one example, the first threshold and the second threshold can be different values. In one example, the second change can occur one or more days after the first change.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2C, various steps of a method 2200 according to an embodiment are shown. As seen in this FIG. 2C, step 2202 comprises receiving first data indicative of a first change to a first aspect of a user account. Next, step 2204 comprises determining a first score associated with the first change, the first score being determined by applying some or all of the first data to a first model to determine the first score. Next, step 2206 comprises receiving second data indicative of a second change to the first aspect of the user account. Next, step 2208 comprises determining a second score associated with the second change, the second score being determined by applying some or all of the second data to the first model to determine the second score. Next, step 2210 comprises aggregating the first score with the second score, resulting in a first aggregate score. Next, step 2212 comprises storing the first aggregate score in a database. Next, step 2214 comprises receiving third data indicative of a third change to a second aspect of the user account, the second aspect of the user account being a different aspect than the first aspect of the user account. Next, step 2216 comprises determining a third score associated with the third change, the third score being determined by applying some or all of the third data to a second model to determine the third score, the second model being different from the first model. Next, step 2218 comprises receiving fourth data indicative of a fourth change to the second aspect of the user account. Next, step 2220 comprises determining a fourth score associated with the fourth change, the fourth score being determined by applying some or all of the fourth data to the second model to determine the fourth score. Next, step 2222 comprises aggregating the third score with the fourth score, resulting in a second aggregate score. Next, step 2224 comprises storing the second aggregate score in the database.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2D, various steps of a method 2300 according to an embodiment are shown. As seen in this FIG. 2D, step 2302 comprises determining, by a processing system comprising a processor, a plurality of first changes to a first aspect of a user account. Next, step 2304 comprises applying, by the processing system, a plurality of first features associated with the first changes to a first model, the first model providing as first output a first plurality of scores. Next, step 2306 comprises aggregating, by the processing system, the first plurality of scores to generate a first aggregate score. Next, step 2308 comprises storing, by the processing system, the first aggregate score in a database. Next, step 2310 comprises determining, by the processing system, a plurality of second changes to a second aspect of the user account, the second aspect being a different aspect than the first aspect. Next, step 2312 comprises applying, by the processing system, a plurality of second features associated with the second changes to a second model, the second model providing as second output a second plurality of scores, the second model being a different model than the first model. Next, step 2314 comprises aggregating, by the processing system, the second plurality of scores to generate a second aggregate score. Next, step 2316 comprises storing, by the processing system, the second aggregate score in a database.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described herein, various embodiments can provide an account health passive monitoring system that includes one or more of the following elements:

1. Real-time scoring—For each account change event, there can be a specific machine learning model that scores the attempted account change in real-time and generates a propensity score to indicate if this account change is suspicious. The propensity scores can be used in the mitigation process where the risky account change events can be reviewed by fraud analysts and/or cancelled directly to avoid further fraudulent actions towards the customer account.

2. Score aggregation—One or more customized aggregation functions can be used to aggregate all propensity scores of multiple changes for a specific kind of account change within a time window so that (in certain embodiments) only one propensity score will be used to represent the account health for that kind of account change. This helps in extracting the most important information from multiple account changes and avoid dealing with redundant information in the subsequent processes.

3. Overall account health score—There can be batch jobs running frequently (e.g., based on one or more relevant business requirements) to store and update the overall account health scores for each customer account (the information can be stored, for example, on the cloud). This enables the system to monitor the account health via combining short-term and long-term account change patterns.

4. Feature Store—A centralized data warehouse that stores common features of each model (and can serve as an inference pipeline). The aggregated model scores regarding the overall customer account health can also be stored in the feature store.

5. Mitigation—A process that uses the model propensity scores to make decisions (e.g., business decisions) in real-time.

6. Integration(s) with other system(s) and/or model(s)—A system according to various embodiments can be plugged into (or otherwise communicate with) other system(s) and/or machine learning model(s) to provide: decision-making support in real-time; and/or frequent and comprehensive monitoring for generic customer account health.

As described herein, various embodiments can provide an account health passive monitoring system that provides one or more aspects of improvement over certain conventional approaches to solve various problems. In various examples, improvement over certain conventional approaches can include:

1. Data dependencies are reduced by using different machine learning models—Since different account change events typically happen at different times, it is conventionally difficult to score all different kinds of account changes in real-time together (e.g., due to data dependencies and service level agreement (SLA) requirements). However, according to various embodiments, a system can score each kind of account change using different models to make sure the training data sets for each model are dependent. In this case, a propensity score towards a single account change event can be generated in real-time.

2. Whole picture of customer account health is provided—Using batch jobs to gather aggregated propensity scores from different machine learning models (according to various embodiments) is an effective way to not only take care of each account change but also to store important changes on the cloud for comprehensive monitoring purposes.

3. Efficiency and flexibility—Customized aggregation functions can be used to capture the most important information for multiple changes happening within a short period of time. This can save time, for example, when reviewing and decisioning. In one example, a time window can be provided to update the aggregated scores, and such time window can be tweaked and changed to meet different needs (e.g., different business needs).

As described herein, various embodiments can provide several technical and commercial benefits over certain conventional approaches to solve various problems. In various examples, such technical and commercial benefits over certain conventional approaches can include:

1. Revenue benefits—The system can provide monetary benefits to a business by canceling and/or flagging suspicious account changes that might be associated with further fraudulent order submissions (this can help avoid financial losses). Furthermore, the comprehensive account health scores according to various embodiments can help a business to find potential fraud patterns and work on precautions to avoid fraud outbreaks in the future.

2. Labor force optimization—The real-time propensity scores generated (according to various embodiments) for each single account change event help a business to make dynamic decisions automatically with less manual work involved (in one example, work that can be avoided can include creating and updating the business rules and reviewing all data for account change events to identify suspicious account changes; in another example, the work that can be avoided can include work that the fraud analysts would otherwise perform on repeated tasks (by use of various embodiments, such fraud analysts can instead spend more time on more complex cases).

3. Infrastructure cost reduction—Batch scoring and generic account health score creation (according to various embodiments) can save a lot of storage space for a business by aggregating propensity scores for different kinds of account changes (rather than, for example, storing all changes in a database). Also, storing the aggregated scores in a key and value pair schema (according to various embodiments) in one or more databases (such as REDIS on cloud) can provide fast access to the customer account health scores (such access can be provided, for example, to one or more other system(s) and/or model(s)). In addition, using a feature store (according to various embodiments) to store the common features from each model and the aggregated scores can reduce the cost to regenerate the features to retrain models.

4. Expandability—In various embodiments, a system can be expanded to include other account changes with minimal changes to the overall architecture and workflow.

5. Reusability—In various embodiments, a system can be used in one or more other use cases and/or in the context of different industries (e.g., including e-commerce platforms and financial departments). In various embodiments, a mechanism can be provided for monitoring account health to avoid account takeover.

As described herein, various embodiments can provide a mechanism to monitor customer account changes in a comprehensive way to avoid potential account takeover and/or avoid further fraud activities.

As described herein, various embodiments can provide an account health passive monitoring system for fraud prevention.

As described herein, various embodiments can provide a solution that can be implemented in different industries (such as, for example, telecommunication, finance and e-commerce).

As described herein, various embodiments can provide one or more mechanisms via which information can be stored as key and value pairs on the cloud and updated automatically in a time window based on relevant business needs.

As described herein, various embodiments can provide an efficient mechanism to prevent fraud from occurring (or to reduce the severity and/or frequency of occurrence of such fraud). In one example, the prevented/reduced fraud can be associated with manipulation of customer accounts as a prelude to fraudulent activities. In various examples, early detection of such manipulation of customer accounts can be provided. In one specific example, early detection can be provided against a case where a fraudster might add himself/herself as an authorized user after hacking into a customer's account and then order valuable devices that would be shipped to the fraudster.

As described herein, various embodiments can provide a mechanism to capture a change to an account's authorized user in real-time and to generate a propensity score for this account change event (e.g., so that a business has the ability to flag and/or cancel a fraudulent account change). In other examples (besides this authorized name change event), the system can monitor other account changes, such as billing address change and account password change. The monitoring of account changes according to various embodiments can provide more insights about the fraud patterns and can help the business to stop the fraud efficiently.

As described herein, various embodiments can automatically provide a cost-friendly whole picture of a customer's account health.

As described herein, various embodiments can provide a mechanism that combines real-time scoring and batch scoring to monitor the health of different accounts.

As described herein, various embodiments can provide a mechanism that uses a different model for each type of account change.

As described herein, various embodiments can provide a mechanism that operates by providing one or more model outputs to one or more functions.

As described herein, various embodiments can provide feedback from one model output into another model.

As described herein, various embodiments can provide for combining (and/or aggregating) scores from different account changes into one score for feedback to other systems and/or for decision making.

As described herein, various embodiments can provide for an effect of all account changes to be updated automatically. In one specific example, multiple account changes throughout the day (and/or hour, minute, etc.) can be updated, monitored, and/or acted upon automatically.

As described herein, various embodiments can provide for feature storage (e.g., by utilizing REDIS storage). In one example, scores can be stored as features for other models. In one example, scores (and/or other data) can be stored as key value pairs (e.g., key=account number; value=each element of a list that has scores and corresponding timestamps).

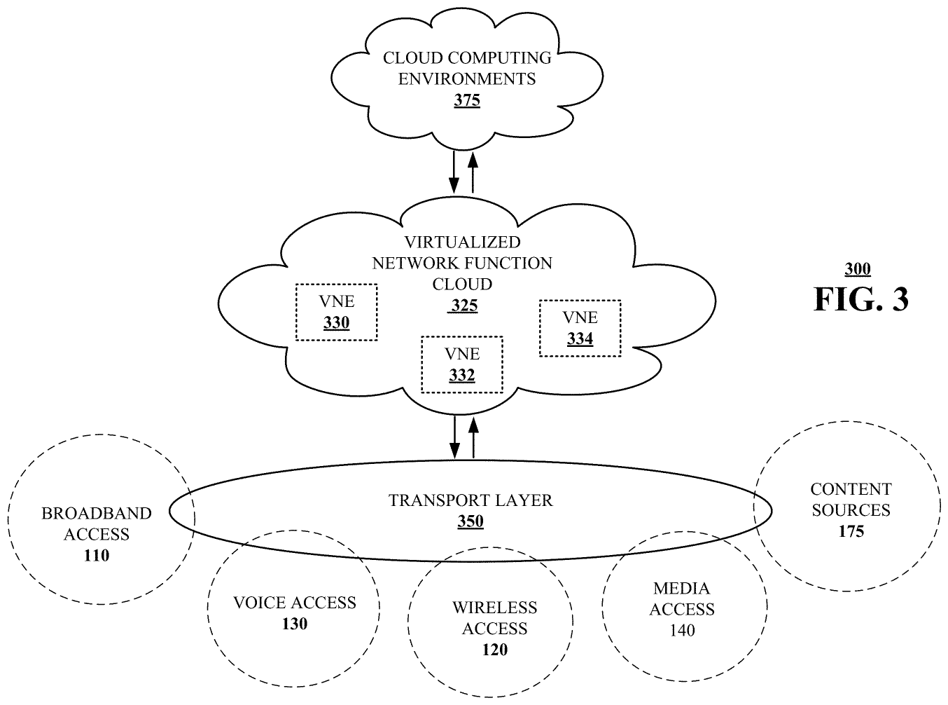

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, some or all of the functions of process 2000, and/or some or all of the methods 2100, 2200, and/or 2300. For example, virtualized communication network 300 can facilitate in whole or in part monitoring a status of a user account, and/or providing fraud detection, and/or providing fraud mitigation, and/or providing fraud prevention.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

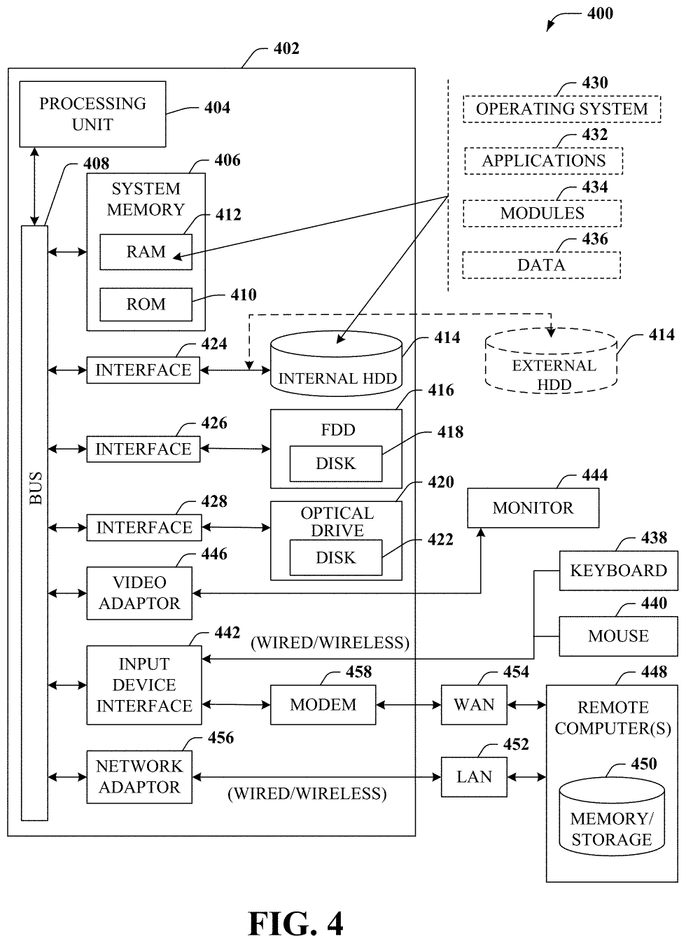

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part monitoring a status of a user account, and/or providing fraud detection, and/or providing fraud mitigation, and/or providing fraud prevention.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

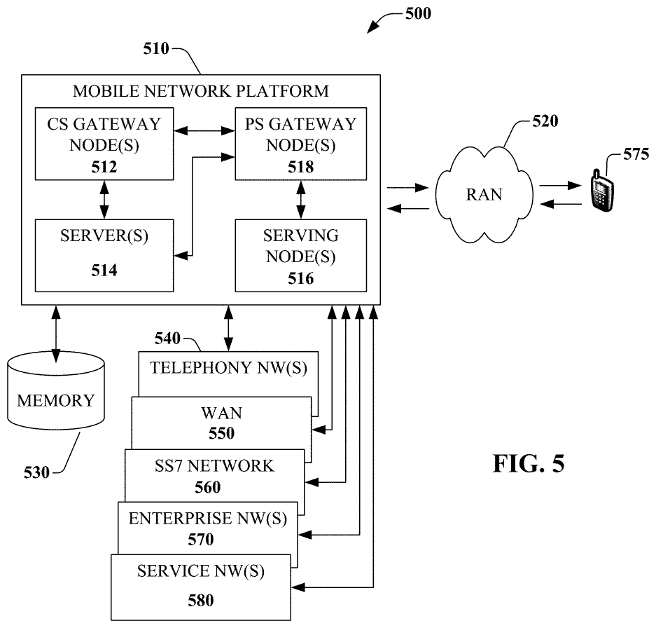

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part monitoring a status of a user account, and/or providing fraud detection, and/or providing fraud mitigation, and/or providing fraud prevention. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

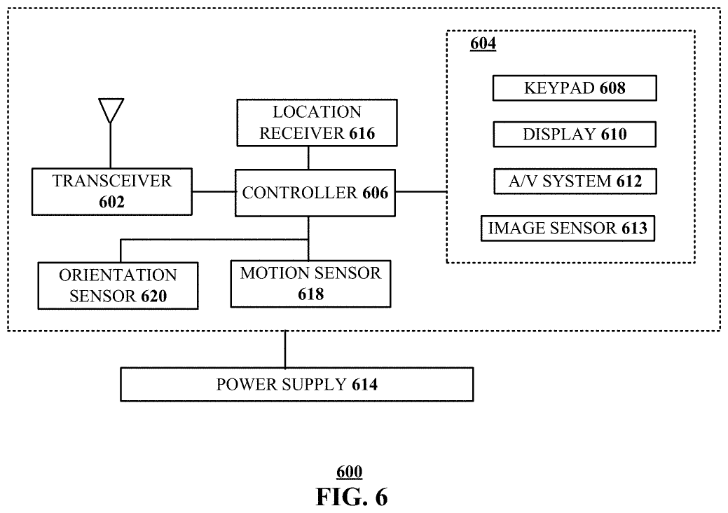

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part monitoring a status of a user account, and/or providing fraud detection, and/or providing fraud mitigation, and/or providing fraud prevention.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically monitoring a status of a user account and/or automatically providing fraud detection, and/or automatically providing fraud mitigation, and/or automatically providing fraud prevention) can employ various AI-based schemes for carrying out various embodiments thereof. Moreover, the classifier can be employed to determine a ranking or priority of each user account and/or each account change. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining a ranking or priority of each user account and/or each account change.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device comprising:
a processing system including a processor; and
a memory that stores executable instructions that, when executed by the processing system, facilitate performance of operations, the operations comprising:
obtaining first information indicative of a first change to a first aspect of a user account;
applying some or all of the first information to a first model to determine a first score associated with the first change;
aggregating the first score with one or more first prior scores associated with one or more prior changes to the first aspect of the user account, resulting in a first aggregate score;
obtaining second information indicative of a second change to a second aspect of the user account;
applying some or all of the second information to a second model, that is different from the first model, to determine a second score associated with the second change;
aggregating the second score with one or more second prior scores associated with one or more prior changes to the second aspect of the user account, resulting in a second aggregate score; and
storing the first aggregate score and the second aggregate score in a database.

2. The device of claim 1, wherein:
the obtaining of the first information occurs in real-time, essentially as the first change is made; and
the obtaining of the second information occurs in real-time, essentially as the second change is made.

3. The device of claim 1, wherein:
the first aspect of the user account is one of: billing address; billing password; billing email; security level; or access ID; and
the second aspect of the user account is one of: billing address; billing password; billing email; security level; or access ID.

4. The device of claim 1, wherein:
the applying some or all of the first information to the first model to determine the first score associated with the first change comprises applying one or more first features associated with the first change to the first model in order to infer the first score; and
the applying some or all of the second information to the second model to determine the second score associated with the second change comprises applying one or more second features associated with the second change to the second model in order to infer the second score.

5. The device of claim 1, wherein:
the aggregating the first score comprises one of: determining a max score from among the first score and each of the first prior scores; determining a last score from among the first score and each of the first prior scores; determining a mean score from among the first score and each of the first prior scores; and determining an optimized max score from among the first score and each of the first prior scores, the optimized max score from among the first score and each of the first prior scores removing an impact of one or more first outliers; and
the aggregating the second score comprises one of: determining a max score from among the second score and each of the second prior scores; determining a last score from among the second score and each of the second prior scores; determining a mean score from among the second score and each of the second prior scores; and determining an optimized max score from among the second score and each of the second prior scores, the optimized max score from among the second score and each of the second prior scores removing an impact of one or more second outliers.

6. The device of claim 1, wherein:
all of the first information is applied to the first model to determine the first score associated with the first change; and
all of the second information is applied to the second model to determine the second score associated with the second change.

7. The device of claim 1, wherein:
the database comprises a feature store;
the applying some or all of the first information to the first model to determine the first score comprises applying one or more first features from the feature store to the first model; and
the applying some or all of the second information to the second model to determine the second score comprises applying one or more second features from the feature store to the second model.

8. The device of claim 1, wherein:
the one or more first prior scores comprises a first plurality of first prior scores;
the one or more second prior scores comprises a second plurality of second prior scores; and
each of the first information, the first plurality of first prior scores, the second information, and the second plurality of second prior scores is obtained on a same day.

9. The device of claim 1, wherein the operations further comprise accessing the first aggregate score and the second aggregate score from the database.

10. The device of claim 9, wherein the operations further comprise facilitating a mitigation of a fraud event based upon the accessing of the first aggregate score and the second aggregate score from the database.

11. A non-transitory machine-readable medium comprising executable instructions that, when executed by a processing system including a processor, facilitate performance of operations, the operations comprising:
receiving first data indicative of a first change to a first aspect of a user account;
determining a first score associated with the first change, the first score being determined by applying some or all of the first data to a first model to determine the first score;
receiving second data indicative of a second change to the first aspect of the user account;
determining a second score associated with the second change, the second score being determined by applying some or all of the second data to the first model to determine the second score;
aggregating the first score with the second score, resulting in a first aggregate score;
storing the first aggregate score in a database;
receiving third data indicative of a third change to a second aspect of the user account, the second aspect of the user account being a different aspect than the first aspect of the user account;
determining a third score associated with the third change, the third score being determined by applying some or all of the third data to a second model to determine the third score, the second model being different from the first model;
receiving fourth data indicative of a fourth change to the second aspect of the user account;
determining a fourth score associated with the fourth change, the fourth score being determined by applying some or all of the fourth data to the second model to determine the fourth score;
aggregating the third score with the fourth score, resulting in a second aggregate score; and
storing the second aggregate score in the database.

12. The non-transitory machine-readable medium of claim 11, wherein each of the first score, the second score, the third score, and the fourth score is stored in the database as part of a respective key-value pair.

13. The non-transitory machine-readable medium of claim 11, wherein:
the first score is stored in the database in association with a first timestamp;
the second score is stored in the database in association with a second timestamp;
the third score is stored in the database in association with a third timestamp; and
the fourth score is stored in the database in association with a fourth timestamp.

14. The non-transitory machine-readable medium of claim 11, wherein the operations further comprise accessing the database to retrieve the first aggregate score and the second aggregate score.

15. The non-transitory machine-readable medium of claim 14, wherein the operations further comprise facilitating a mitigation of a fraud event based upon the first aggregate score and the second aggregate score that are retrieved from the database.

16. The non-transitory machine-readable medium of claim 11, wherein:
the first aspect of the user account is one of: billing address; billing password; billing email; security level; or access ID;
in a first case that the first aspect of the user account is billing address, the second aspect of the user account is one of: billing password; billing email; security level; or access ID;
in a second case that the first aspect of the user account is billing password, the second aspect of the user account is one of: billing address; billing email; security level; or access ID;
in a third case that the first aspect of the user account is billing email, the second aspect of the user account is one of: billing address; billing password; security level; or access ID;
in a fourth case that the first aspect of the user account is security level, the second aspect of the user account is one of: billing address; billing password; billing email; or access ID; and
in a fifth case that the first aspect of the user account is access ID, the second aspect of the user account is one of: billing address; billing password; billing email; or security level.

17. A method comprising:
determining, by a processing system comprising a processor, a plurality of first changes to a first aspect of a user account;
applying, by the processing system, a plurality of first features associated with the first changes to a first model, the first model providing as first output a first plurality of scores;
aggregating, by the processing system, the first plurality of scores to generate a first aggregate score;
storing, by the processing system, the first aggregate score in a database;
determining, by the processing system, a plurality of second changes to a second aspect of the user account, the second aspect being a different aspect than the first aspect;
applying, by the processing system, a plurality of second features associated with the second changes to a second model, the second model providing as second output a second plurality of scores, the second model being a different model than the first model;
aggregating, by the processing system, the second plurality of scores to generate a second aggregate score; and
storing, by the processing system, the second aggregate score in the database.

18. The method of claim 17, wherein:
each of the first changes had occurred on a first same day; and
each of the second changes had occurred on a second same day.

19. The method of claim 17, wherein each of the first changes and the second changes has occurred on a same day.

20. The method of claim 17, wherein the method further comprises:
accessing the database to retrieve the first aggregate score and the second aggregate score; and
facilitating a mitigation of a fraud event based upon the first aggregate score and the second aggregate score that are retrieved from the database.
